(19) United States
(12) Patent Application Publication
(10) Pub. No.: US 2026/0304589 A1
(43) Pub. Date: Oct. 1, 2026

(54) PLASMA SYSTEMS AND METHODS FOR GENERATION AND USE OF HIGH-INTENSITY LIGHT

(71) Applicant: UNIVERSITY OF MARYLAND, COLLEGE PARK, College Park, MD (US)

(72) Inventors: Liangbing HU, Woodbridge, CT (US); Qian ZHANG, Milford, CT (US); Ji-Cheng ZHAO, Dublin, OH (US)

(21) Appl. No.: 19/575,393

(22) Filed: Mar. 23, 2026

Related U.S. Application Data
(60) Provisional application No. 63/777,773, filed on Mar. 26, 2025.

(51) Int. Cl. H05H 1/48; B22F 3/105; B23K 10/02

(52) U.S. Cl. CPC H05H 1/48; B22F 3/105; B23K 10/02; H05H 2245/40

(57) ABSTRACT

A plasma can be generated using a pair of electrodes spaced apart from each other by a gap along a first direction. At least one of the electrodes can have a plurality of first projecting portions that extend along the first direction toward the other electrode of the pair. The generated plasma can produce light, at least a portion of which can be used in a particular application, such as illumination, manufacturing or fabrication (e.g., sintering, welding, brazing, photolithography, etc.), and deterrence/defense (e.g., blinding). In some embodiments, the light may be high intensity and/or broadband.

### CROSS-REFERENCE TO RELATED APPLICATION(S)

The present application claims the benefit of and priority under 35 U.S.C. § 119(e) to and is a non-provisional of U.S. Provisional Application No. 63/777,773, filed Mar. 26, 2025, and entitled “Laser-Free Plasmas Light Source,” which is hereby incorporated by reference herein in its entirety.

### FIELD

The present disclosure relates generally to plasma systems and methods, and more particularly, to generation and use of light based on the plasma, for example, without employing a laser (e.g., to generate the plasma and/or the light).

### BACKGROUND

Conventional lighting systems often rely on lasers to generate high-intensity light for specialized applications in manufacturing, medicine, and defense. While lasers can produce powerful illumination, their output is generally limited to a single wavelength (or multiple wavelengths within a narrow linewidth, for example, <50 nm), which restricts their utility in scenarios requiring broadband or white light. To overcome this spectral limitation, some systems utilize high-powered lasers to initiate and sustain a plasma that serves as a secondary light source. However, these laser-based plasma systems are frequently complex to implement and necessitate expensive, high-voltage power supplies to operate. Moreover, the reliance on sensitive laser components can increase the overall cost and maintenance requirements of the lighting assembly. Embodiments of the disclosed subject matter may address one or more of the above-noted problems and disadvantages, among other things

### SUMMARY

Embodiments of the disclosed subject matter provide plasma systems and methods for generation and use of light. A volumetric plasma can be generated and sustained between a pair of electrodes, at least one of which features a plurality of projecting portions to facilitate gas breakdown at low voltage. In some embodiments, the system can avoid the complexity of laser-based plasma initiation via the disclosed electrode configurations to produce stable light emission suitable for a variety of applications, such as, but not limited to, photolithography, sintering, and optical deterrence. In some embodiments, the light can be broadband and/or high intensity.

In one or more embodiments, a method can comprise generating a volumetric plasma using a pair of electrodes spaced apart from each other by a gap along a first direction. At least one of the pair of electrodes can comprise a plurality of first projecting portions that extend along the first direction toward the other electrode of the pair. Each electrode can comprise a material having a melting temperature of at least 1000 K. The generated volumetric plasma can produce broadband light. The method can further comprise using at least a portion of the broadband light.

In one or more embodiments, a system can comprise a plasma light source, an electrical power source, and a control system. The plasma light source can comprise a pair of electrodes spaced apart from each other by a gap along a first direction. At least one of the pair of electrodes can comprise a plurality of first projecting portions that extend along the first direction toward the other electrode of the pair. Each electrode can comprise a material having a melting temperature of at least 1000 K. The electrical power source can be electrically coupled to the plasma light source. The control system can be operatively coupled to the electrical power source and can be configured to control operation thereof. The controller can comprise one or more processors and computer-readable storage media storing instructions that, when executed by the one or more processors, cause the electrical power source to apply voltage between the pair of electrodes such that a volumetric plasma is generated. The generated plasma can produce broadband light and can have a temperature in a range of 1,000-10,000 K, inclusive.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. In some figures, the propagation of light has not been shown or has been illustrated using block arrows or solid/dashed lines rather than employing ray diagrams Throughout the figures, like reference numerals denote like elements.

FIG. 1A illustrates aspects of a plasma system that may be used as a light source, according to one or more embodiments of the disclosed subject matter.

FIGS. 1B-1F are simplified schematic diagrams illustrating aspects of different electrode configurations for a plasma system, according to one or more embodiments of the disclosed subject matter.

FIG. 2A is a simplified schematic diagram of a plasma system having a pair of electrodes with short projecting portions, according to one or more embodiments of the disclosed subject matter.

FIG. 2B shows images of a carbon felt electrode with bundles of fiber projecting portions that may be used in a plasma system, according to one or more embodiments of the disclosed subject matter.

FIG. 2C is a simplified schematic diagram of another plasma system having a pair of electrodes with short and long projecting portions, according to one or more embodiments of the disclosed subject matter.

FIG. 2D shows SEMS images of a carbon felt electrode with short and long fiber projecting portions that may be used in a plasma system, according to one or more embodiments of the disclosed subject matter.

FIG. 2E illustrates aspects of initiating and maintaining a plasma by changing a distance of a gap between a pair of electrodes, according to one or more embodiments of the disclosed subject matter.

FIG. 2F depicts a generalized example of a computing environment in which the disclosed technologies may be implemented.

FIG. 3A is a simplified schematic diagram illustrating aspects of another plasma system for generating and/or using light, according to one or more embodiments of the disclosed subject matter.

FIG. 3B illustrates aspects of maintaining gap spacing between electrodes during operation of a plasma system, according to one or more embodiments of the disclosed subject matter.

FIG. 3C is a graph comparing the emission intensity spectra of light generated by a plasma system (USP) at different plasma currents (25A, 35A, and 45A) to the spectrum of solar radiation.

FIG. 3D illustrates aspects of initiating and expanding a plasma between electrodes of a plasma system, according to one or more embodiments of the disclosed subject matter.

FIG. 3E is a series of images illustrating the transition from contacting electrodes to gap formation in generating a plasma, according to one or more embodiments of the disclosed subject matter.

FIGS. 4A-4B illustrate aspects of plasma systems employing one or more reflective elements, according to one or more embodiments of the disclosed subject matter.

FIGS. 5A-5B illustrate aspects of plasma systems employing one or more refractive elements, according to one or more embodiments of the disclosed subject matter.

FIGS. 6A-6B illustrate aspects of plasma systems employing gas cells or housings, according to one or more embodiments of the disclosed subject matter.

FIG. 6C illustrates aspects of a plasma system employing a cooling device, according to one or more embodiments of the disclosed subject matter.

FIGS. 7A-7B illustrates aspects of photolithography setups employing plasma systems as light sources, according to one or more embodiments of the disclosed subject matter.

FIG. 7C illustrates aspects of a reaction setup employing a plasma system as a light source, according to one or more embodiments of the disclosed subject matter.

FIG. 8A is a simplified schematic diagram for an experimental setup of a plasma system for use as a light source.

FIG. 8B is a photograph of a plasma system according to the setup of FIG. 8A.

FIG. 8C shows images of one of the electrodes used in the plasma system of FIG. 8B.

FIG. 8D is a series of images showing operation of the plasma light source of FIG. 8B at different times after plasma initiation.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted. As used herein, the use of “can” and “may” is intended to indicate that a particular recitation is optional.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Volumetric Plasma: A three-dimensional volume of electrons, ions, and/or excited molecules created and/or maintained by application of an electric field between electrodes. In some embodiments, the plasma can be generated via application of a direct current (DC) voltage, an alternating current (AC) voltage (e.g., radio frequency (RF), for example, in a range of 3 kHz to 300 GHz), or other waveform (e.g., pulsed voltage waveform) between the electrodes. In some embodiments, the volumetric plasma is considered an ultrahigh temperature, stable plasma (USP). In some embodiments, the temperature of the generated plasma is at least 1000 K (e.g., in a range of 1000-10000K, inclusive, such as 3000-8000 K, inclusive).

Strand: An elongated (e.g., columnar) structure formed by a plurality of strands of fibers. In some embodiments, fibers within a strand can be aligned (e.g., parallel to and/or extending along an axial direction of the strand). Alternatively or additionally, in some embodiments, fibers within a strand can be twisted or interwoven, for example, wrapping along the axial direction of the strand and/or other fibers. In some embodiments, the strands can be formed of carbon or metal fibers (e.g., a refractory metal or refractory metal alloy). In some embodiments, a carbon cloth or felt can be formed by carbonizing (e.g., at a temperature of at least 1000 K) polyacrylonitrile (PAN) or rayon fibers. In some embodiments, each fiber can have a cross-sectional dimension (e.g., diameter) less than or equal to 500 μm, for example, in a range of 1-100 μm, inclusive. In some embodiments, a cross-sectional dimension of the strand is at least 2 times (e.g., at least 10 times) a cross-sectional dimension of one (or each) of the constituent fibers.

Fiber bundle: An elongated (e.g., columnar) structure formed by a plurality of strands of fibers. In some embodiments, the strands can be aligned (e.g., parallel to and/or extending along an axial direction of the bundle). Alternatively or additionally, in some embodiments, the strands can be twisted or interwoven, for example, wrapping around the axial direction of the bundle and/or other strands. In some embodiments, a cross-sectional dimension of the fiber bundle is at least 2 times (e.g., at least 10 times) a cross-sectional dimension of one (or each) of the constituent strands.

Cloth or Felt: A structure formed of a plurality of fibers, for example, woven together (e.g., to form a cloth) or otherwise coupled together (e.g., matting, condensing, and/or pressing fibers together to form a felt). In some embodiments, the cloth or felt can be formed of carbon or metal fibers (e.g., a refractory metal or refractory metal alloy), or strands thereof. In some embodiments, a carbon cloth or felt can be formed by carbonizing (e.g., at a temperature of at least 1000 K) polyacrylonitrile (PAN) or rayon fibers. In some embodiments, each fiber can have a cross-sectional dimension (e.g., diameter) less than or equal to 500 μm, for example, in a range of 1-100 μm, inclusive.

Inert Gas: One or more gases that do not undergo a chemical reaction when subjected to the temperature of a generated plasma and/or the material of the electrodes. In some embodiments, the inert gas is selected from the group consisting of nitrogen, argon, helium, neon, krypton, xenon, radon, and oganesson.

Refractory material: A material (e.g., element or compound) having a melting temperature (e.g., at atmospheric pressure) of at least 1000 K, for example, at least 1850 K (~1580 °C). In some embodiments, a refractory material can be as defined in ASTM C71-01, “Standard Terminology Relating to Refractories,” August 2017, which is incorporated herein by reference. In some embodiments, the refractory material can be carbon (e.g., graphite, carbon cloth, carbon felt, carbon nanotubes), refractory metals, refractory metal alloys, refractory ceramics, or any combination thereof.

Refractory metal or refractory metal alloy: A metal or metal alloy having a melting temperature (e.g., at atmospheric pressure) of at least 1000 K, for example, at least 2100 K (~1850 °C). In some embodiments, the refractory metal can be niobium, molybdenum, tantalum, tungsten, rhenium, alloys thereof, or any combination thereof.

Light: Electromagnetic radiation having a wavelength within the visible spectrum (400-700 nm, inclusive) or bands adjacent thereto (e.g., ultraviolet and infra-red), for example, in a wavelength range from 100 nm to 100 μm, inclusive. In some embodiments, the light from the generated plasma can be high-intensity (e.g., having an intensity at one or more wavelengths greater than or equal to 1000 W/m²) and/or broadband (e.g., having appreciable components spanning at least 200 nm of the electromagnetic spectrum, for example, in the visible range).

### INTRODUCTION

Disclosed herein are plasma systems and methods for generation and use of light, for example, high-intensity and/or broadband light. Unlike conventional light sources, embodiments of the disclosed subject matter are able to produce such light without relying on a laser to initiate or sustain the plasma. Instead, a volumetric plasma can be generated between electrodes, at least one of which has a plurality of projecting portions. In some embodiments, the projecting portions can help initiate and/or sustain the volumetric plasma over a larger area, for a longer time, and/or at lower power input than conventional plasma generation techniques.

The light generated by the disclosed systems and methods can be useful for various applications, such as but not limited to manufacturing (e.g., lithography), metrology, medicine, and defense. In some embodiments, at least a portion of the light from the plasma system can be focused, for example, for use in sintering, welding, and/or brazing. Alternatively or additionally, in some embodiments, at least a portion of the light from the plasma system can be used for illuminating an area or an object. In some embodiments, one or more optical elements can be provided for redirecting, focusing, and/or otherwise manipulating the light from the generated plasma (e.g., within the plasma system or downstream from the plasma system). For example, portions of the light from the plasma system can be selected based on position (e.g., spatial filtering, patterning with a photomask, etc.) and/or wavelength (e.g., using an optical filter, for example, to select a particular waveband, such as infrared light) for a particular application. In some embodiments, because of its high intensity, the plasma system can be used for deterrence or defense applications, for example, by blinding a person and/or a sensor (e.g., optical sensor), or otherwise disabling a sensor or sensing system (e.g., by optical heating or sensor overload).

In some embodiments, the plasma can be generated using any of the systems or methods disclosed in U.S. Publication No. 2026/0013030, published Jan. 8, 2026, and entitled “Volumetric Plasmas, and Systems and Methods for Generation and Use Thereof,” which systems and methods are hereby incorporated by reference herein. For example, in some embodiments, the plasma can be generated at a low breakdown voltage (e.g., ≤50 V) and can reach ultrahigh temperatures (e.g., up to 8000 K) at low current (e.g., ≤50 A). In some embodiments, the plasma can be formed as a volumetric plasma between a pair of electrodes separated by a gap. In some embodiments, the characteristics of the plasma (e.g., distribution, size and/or location of the ultrahigh temperature reaction zone, etc.) can be adjusted by controlling the gap and flow field between the electrodes, varying plasma power, applying an external magnetic field, etc. In some embodiments, the plasma can exhibit high temperatures (e.g., >1000 K, such as 1000-10000 K or 3000-8000 K) over relatively large areas (e.g., ≥1 cm²).

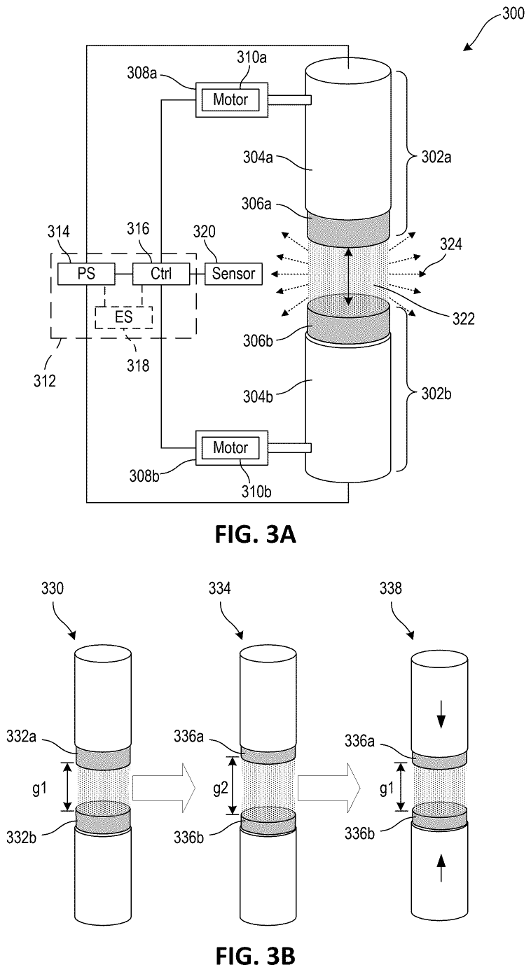

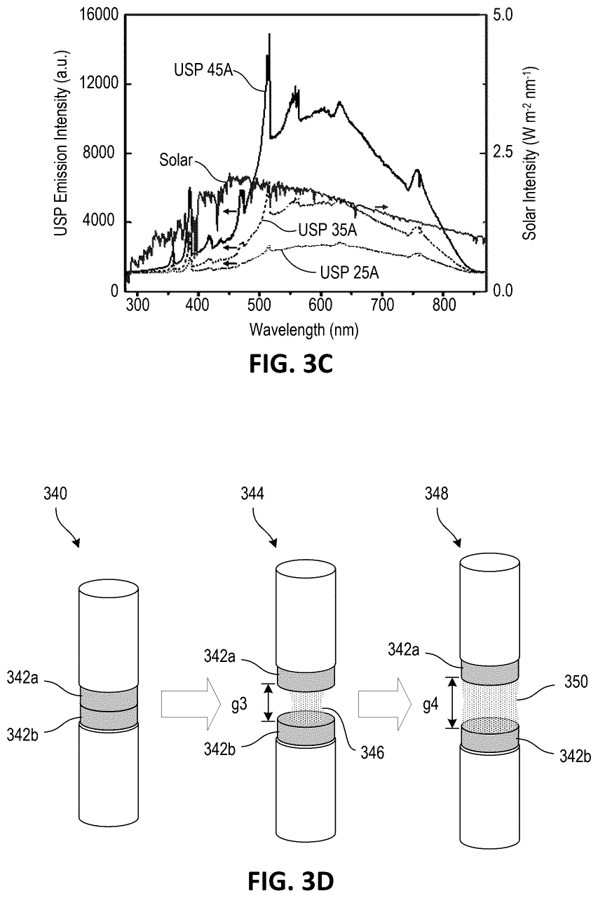

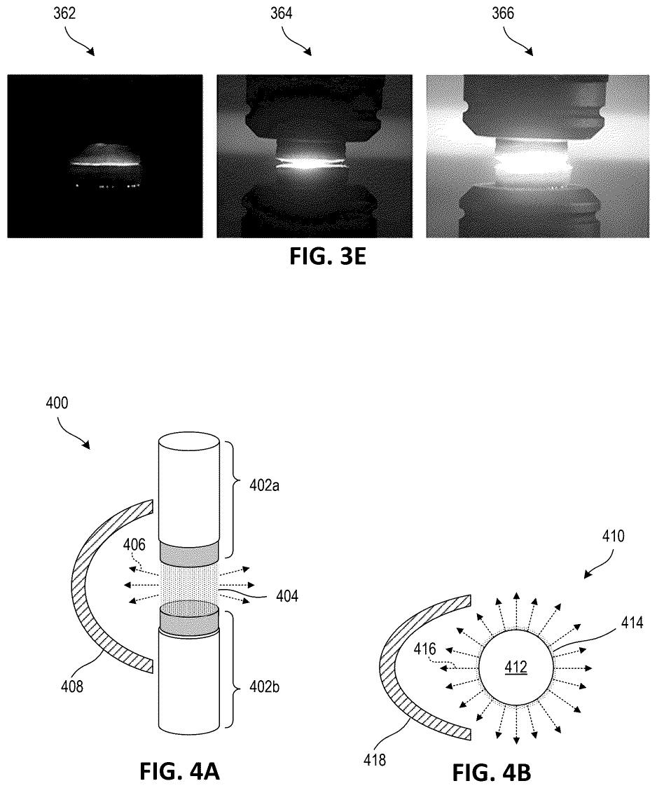

In some embodiments, the plasma can exhibit enhanced temporal stability, enhanced spatial uniformity, or both. For example, the plasma can be substantially stable over time, with a peak temperature at a point within its volume, an average temperature across its volume, and/or a temperature at a point within its volume that varies by no more than 10% for at least 1 minute (e.g., ≥10 minutes). Alternatively or additionally, the plasma can have a substantially uniform temperature across its volume (or at least across its lateral area in a plane perpendicular to a thickness of the gap), for example, a temperature at each point in the plasma being no more than 10% from a peak temperature or an average temperature across the plasma. In some embodiments, the temperature of the plasma, the intensity of light, and/or the light spectrum emitted by the plasma can be repeatably and precisely controlled, for example, by simply varying the current between the electrodes (e.g., as shown in FIG. 3C).

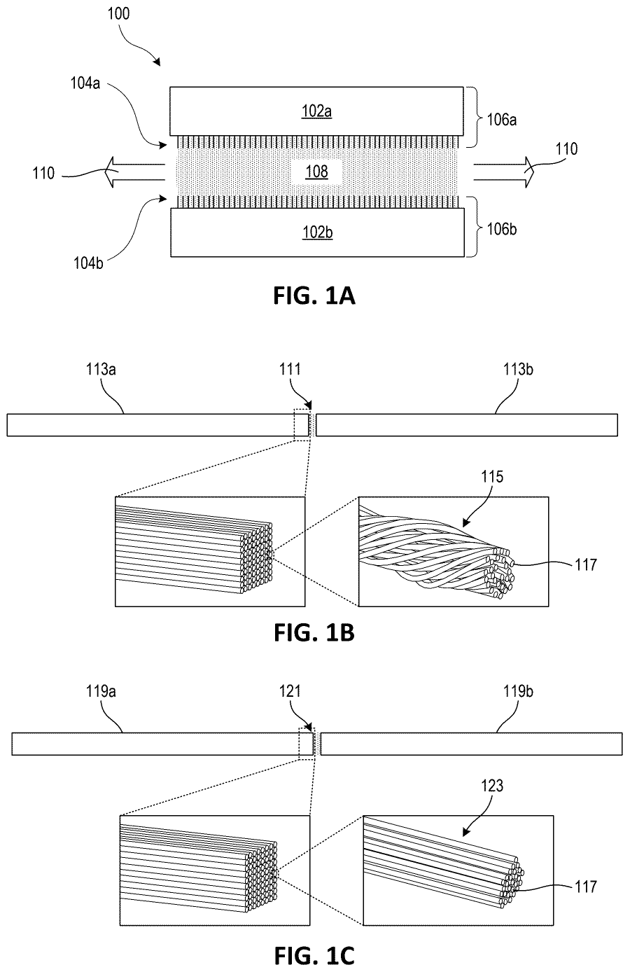

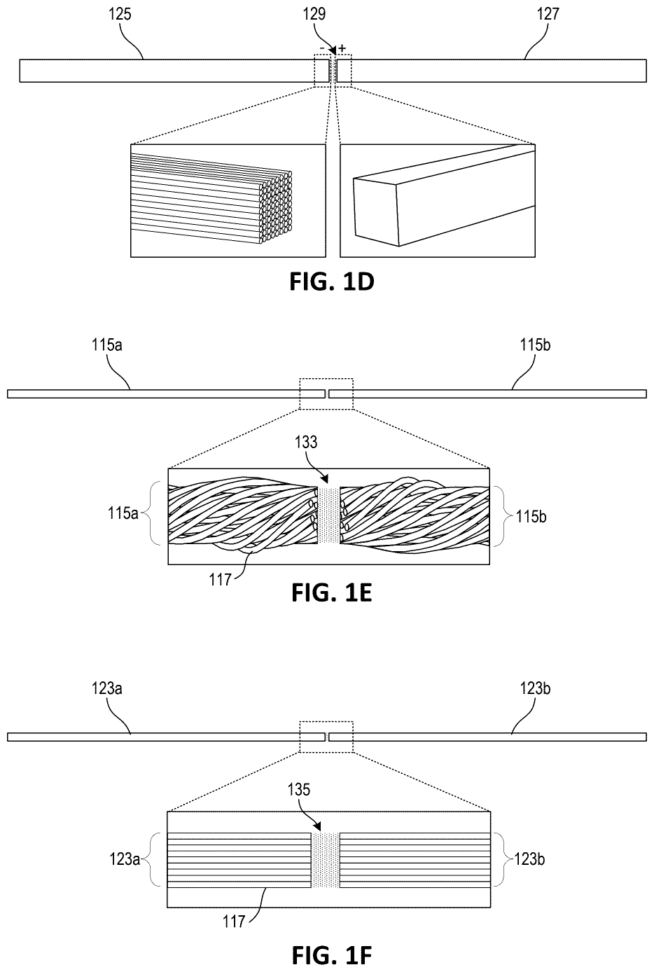

In some embodiments, the plasma can be generated by applying voltage between a pair of electrodes 106a, 106b separated by a gap 108, with surfaces of one or both of the electrodes facing the gap 108 having projecting portions 104a, 104b (e.g., pillars, fibers, tips, or other surface protrusions), for example, as shown in FIG. 1A. The plasma generated within gap 108 can yield light 110 having a high-intensity, for example, having intensities across the 500-800 nm wavelength range of at least 1000 W/m² (e.g., measured outside the gap 108). In some embodiments, the light 110 can be substantially broadband (e.g., white), for example, with intensities in the 500-800 nm wavelength range being greater than a minimum value (e.g., a measured intensity at a wavelength of about 450 nm or less).

In some embodiments, the use of the projecting portions can help decrease the voltage needed for gas breakdown and/or allow a uniform volumetric plasma to be achieved at a lower current and power. In particular, the projecting portions can produce enhanced electric fields that merge across the surface of the electrodes, accelerate the Townsend breakdown to arc transition, expand the plasma size and volume, and increase the plasma uniformity, unlike conventional arc discharge. Moreover, the expansion can generate a collective heating effect that can help to stabilize the plasma.

In some embodiments, the first electrode 106a and the second electrode 106b can be formed of electrically-conductive materials that can withstand the plasma temperature, for example, having melting temperatures (e.g., at atmospheric pressure) that is at least 1000 K. For example, the first electrode 106a and/or the second electrode 106b can be formed of refractory materials (e.g., carbon, refractory metal or alloy, and/or refractory ceramic). In some embodiments, the base layers 102a, 102b of the electrodes 106a, 106b can be formed of an electrically-conductive material different from that of the respective plurality of projecting portions 104a, 104b. For example, the base layer can be graphite, and the projecting portions can be refractory metal or carbon. Alternatively, in some embodiments, the base layers and the projecting portions of one or both electrodes 106a, 106b can be formed of a same electrically-conductive material.

In the illustrated example of FIG. 1A, the electrodes 106a, 106b are illustrated as planar structures. However, other configurations for the electrodes are also possible according to one or more contemplated embodiments. For example, in some embodiments, one or both of the electrodes (or a portion thereof, for example, forming the projecting portions 104a and/or 104b) can comprise a fiber bundle. In the illustrated example of FIG. 1B, a pair of fiber bundles 113a, 113b are separated by a gap 111 to function as the pair of electrodes in a plasma light source, and the fiber bundles are formed (e.g., woven or coupled together) of individual yarn strands 115 comprising fibers 117 (e.g., carbon) having a twisted configuration. In some embodiments, the fibers (or at least a majority thereof) can extend along (e.g., aligned with) a longitudinal axis of the respective fiber bundle and/or a direction of the thickness of the gap 111. The plasma can be generated within the gap 111 between facing ends of the fiber bundles, with the individual fibers 117 exposed from the respective end faces acting as the projecting portions to allow volumetric plasma formation. Alternatively or additionally, fiber bundles 119a, 119b separated by a gap 121 can be formed (e.g., woven or coupled together) of aligned fiber strands 123 comprising fibers 117 (e.g., carbon) having a straight or parallel configuration, as shown in FIG. 1C. In some embodiments, one or both of the electrodes (or a portion thereof, for example, forming the projecting portions 104a and/or 104b) can comprise a fiber strand. For example, a pair of yarn strands 115a, 115b can be separated by a gap 133 to function as the pair of electrodes as shown in FIG. 1E, or a pair of aligned fiber strands 123a, 123b can be separated by a gap 135 to function as the pair of electrodes as shown in FIG. 1F. In some embodiments, the fiber bundles or strands can be tailored (e.g., thickness, length, etc.) to a desired plasma volume and/or a desired system configuration or application scenario, for example, the shape of a support member or base layer of an electrode in a plasma-based light system. In some embodiments, the use of carbon fibers for the fiber bundles can improve and/or extend a lifetime of the plasma system.

In some embodiments, one of the electrodes can be replaced with a solid material having a flat surface (e.g., without any projecting portions and/or having an average surface roughness less than 1 μm) facing the gap. For example, FIG. 1D illustrates an electrode configuration for a plasma light source employing a fiber bundle 125 and a conductive solid member 127 separated by a gap 129. In some embodiments, the conductive solid member (e.g., graphite electrode) can operate as an anode, while the fiber bundle 125 (e.g., similar to bundle 113a or 119a) can operate as a cathode. In some embodiment, the plurality of strands in the fiber bundle 125 and facing the gap 129 can help initiate the plasma as well as ensure uniform and stable plasma operation over time.

### Plasma Systems for Light Generation

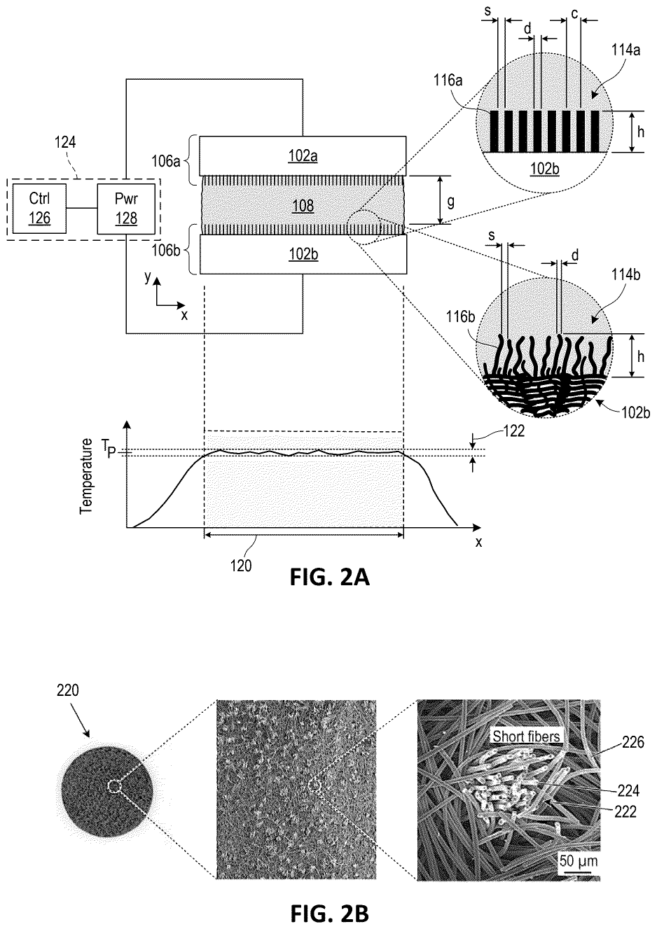

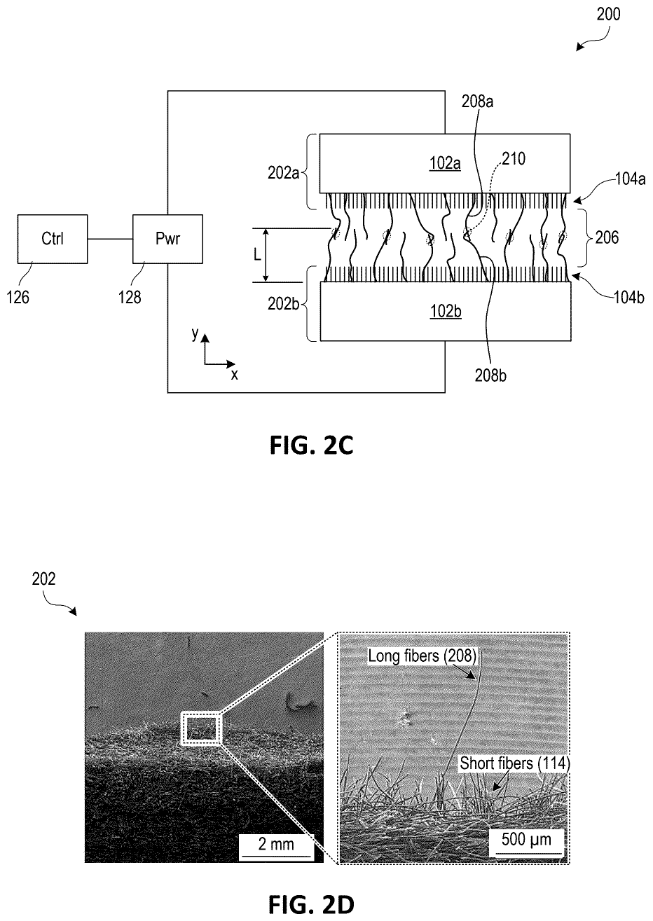

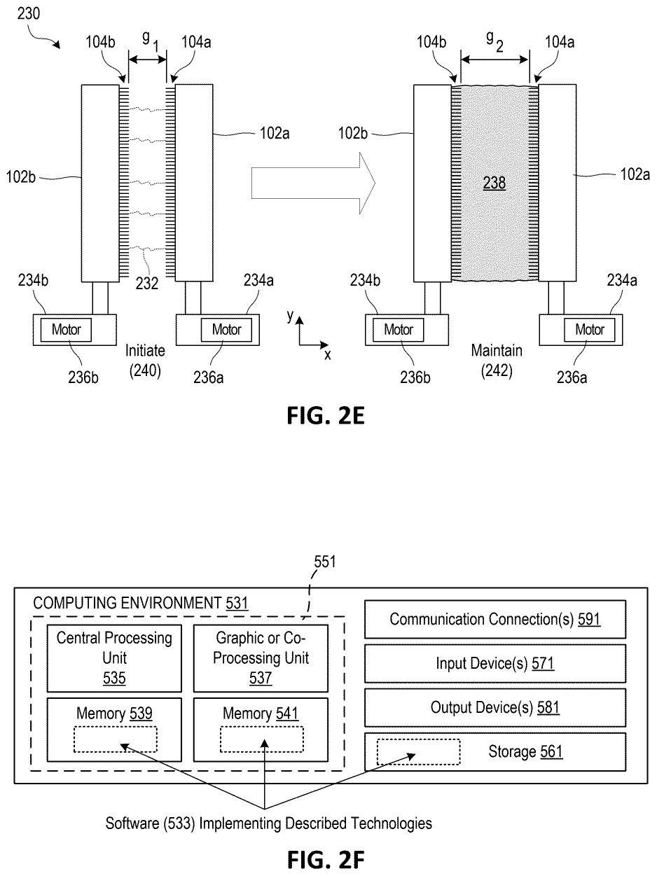

FIG. 2A shows a plasma system with a first electrode 106a, a second electrode 106b, an electrical power supply 128, and a controller 126. In the illustrated example, the first electrode 106a is separated from a second electrode 106b by a gap 108 of thickness, g. In the illustrated example, each electrode has a plurality 114 of projecting portions 116 that extend (e.g., along the y-direction) toward the other electrode; however, in some embodiments, only one of the electrodes may be provided with projecting portions. In some embodiments, the thickness, g, of the gap 108 can be less than 10 cm, for example, in a range of 1 mm to 5 cm. A voltage (DC, AC, or other waveform, such as a pulsed voltage waveform) can be applied across the electrodes 106a, 106b by electrical power supply 128 to form a plasma within the gap 108. In some embodiments, during the plasma, a peak voltage applied between the electrodes 106a, 106b can be less than or equal to 100 V (e.g., ≤50 V), and/or a peak current between the electrodes 106a, 106b can be less than or equal to 100 A (e.g., ≤50V). In some embodiments, the plasma may be generated without application of an external magnetic field.

In some embodiments, the plasma can be generated at any pressure, for example, in a range from 1 Torr to 10 atm, inclusive. In some embodiments, the plasma can exhibit a substantially uniform temperature across a lateral extent 120 (e.g., in the x-z plane) of the plasma. In some embodiments, the lateral extent 120 of the plasma can be at least 1 mm, for example, in a range of 1 mm to 100 cm, inclusive. In some embodiments, the temperature at different points in the plasma along its lateral extent 120 can be within a narrow band 122 around a plasma temperature, T_{P}, for example, less than or equal to 10% of the plasma temperature (e.g., band=±50 K for T_{P}=1000 K). In some embodiments, the plasma temperature, T_{P}, can be at least 1000 K, for example, in a range of 1000-10000 K, inclusive, such as 1000-8000 K, inclusive, or 3000-8000 K, inclusive. Alternatively, in some embodiments, the volumetric plasma (generated within gap 108) can be a non-thermal or cold plasma, for example, where the temperature of electrons is greater than 1000 K while the temperature of heavy species (e.g., ions and neutral particles) is less than 1000 K (e.g., at or approaching room temperature). In some embodiments, the plasma temperature, T_{P}, can be an average temperature across the lateral extent 120 of the plasma, or a temperature at a center (e.g., in the x-z plane) of the lateral extent 120 of the plasma.

In some embodiments, the plasma temperature, T_{P}, can be changed by selecting or altering the power input from power supply 128 (e.g., with higher powers corresponding to higher temperatures), selecting or altering the distance, g, of the gap 108 (e.g., with smaller gaps corresponding to higher temperatures), and/or selecting or altering the gas pressure between the two electrodes 106a, 106b (e.g., with higher pressures corresponding to higher temperatures). In some embodiments, the volumetric plasma can be temporally stable, for example, such that the profile of temperature across lateral extent 120 and/or plasma temperature, T_{P}, stays about the same for a substantially constant power input (e.g., power of a DC signal, power and frequency for an AC signal, power and frequency for a pulsed voltage waveform, etc.) for any amount of time, for example, at least 1 minute (e.g., ≥10 minutes).

Controller 126 can control operation of the electrical power supply 128, for example, timing, application, and/or magnitude of the voltage, current, or electrical power applied across the electrodes 106a, 106b, which may in turn control characteristics of the plasma (e.g., on/off, temperature, etc.) and/or light resulting therefrom (e.g., on/off state, intensity, emission spectra, etc.). In the illustrated example, controller 126 is operatively coupled to the electrical power supply 128. Alternatively or additionally, controller 126 and the electrical power supply 128 may be considered part of a unitary system, for example, different modules of a control system 124. In some embodiments, controller 126 can control other aspects of a system, for example, size of gap 108, pressure between electrodes 106a, 106b, and/or flow characteristics (e.g., gas flow rate, gas flow composition, etc.).

In the illustrated example of FIG. 2A, the projecting portions extend from a base layer 102a, 102b of the respective electrode 106a, 106b. In some embodiments, the projecting portions (of one or both electrodes) can be disposed on or formed from a surface of the base layer, for example, pillars 116a of plurality 114a in the top inset of FIG. 2A. Alternatively or additionally, in some embodiments, the projecting portions (of one or both electrodes) can be exposed or cut surface portions of the base layer, for example, fibers 116b of plurality 114b in the bottom inset of FIG. 2A. In some embodiments, each projecting portion 116 can have a cross-sectional dimension (e.g., a maximum or minimum cross-sectional dimension in the x-z plane, for example, a diameter), d, less than or equal to 500 μm. In some embodiments, the cross-sectional dimension, d, for the projecting portions 116 can be greater than 1 μm, for example, in a range of 1-100 μm, inclusive. In some embodiments, the cross-sectional dimension, d, may represent an average of each of the projecting portions 116, with the cross-sectional dimensions of the projecting portions 116 being within 10% of the average.

In some embodiments, the spacing, s, between adjacent projecting portions 116 (e.g., along the x-direction, along the z-direction, and/or along the x-z plane) can be less than or equal to 1 mm. In some embodiments, the spacing, s, can be about the same or less than the cross-sectional dimension, d, for example, less than or equal to 100 μm (e.g., in a range of 1-50 μm, inclusive). In some embodiments, the spacing, s, may represent an average spacing across the plurality 114. In some embodiments, the individual spacings between pairs of projecting portions 116 can be within 10% of the average. In some embodiments, the combination of the cross-sectional dimension, d, and spacing, s, can yield a center-to-center spacing, c, less than 1 mm, for example, 1-100 μm, inclusive. Alternatively or additionally, the plurality 114 can exhibit a density of at least 10⁴ projecting portions per cm², for example, about 10⁵ portions/cm².

In some embodiments, the length, h, of the projecting portions 116 (e.g., along the y-direction from a surface of the base layer) can be greater than its cross-sectional dimension, d. Alternatively or additionally, the length, h, of the projecting portions 116 can be less than the gap size, g. In some embodiments, the length, h, of the projecting portions 116 can be greater than or equal to 100 μm and/or less than or equal to 1 cm, for example, in a range of 200-500 μm, inclusive. In some embodiments, the length, h, may represent an average length across the plurality 114. In some embodiments, the length of each projecting portion 116 can be within 10% of the average. In some embodiments, each projecting portion can be substantially straight and extend substantially parallel to a thickness of the gap (e.g., parallel to the y-direction), for example, as shown by pillars 116a in FIG. 2A. Alternatively or additionally, in some embodiments, each projecting portion can deviate from being substantially straight along at least part of its length, and/or have a part at an angle with respect to a thickness of the gap (e.g., extending in the x-z plane), for example, as shown by fibers 116b in FIG. 2B, in which case the length, h, can be the distance the projecting portion extends along the y-direction.

In some embodiments, the projecting portions can be formed by a three-dimensional printing modality, such as but not limited to laser-based direct energy deposition or laser powder-bed fusion. Alternatively or additionally, in some embodiments, the array of projecting portions can be formed from the underlying base layer, for example, by cutting, abrading, and/or roughening a surface of a cloth or felt formed of refractory material fibers (e.g., carbon or metal fibers). In some embodiments, the underlying base layer can comprise woven fibers, and the projecting portions can be arranged in bundles based on the weave pattern. For example, FIG. 2B illustrates a configuration for an electrode 220 that has bundles 222 of cut fibers 224 held together but separated by laterally-oriented fibers 226. Within each bundle 222, the cut fibers 224 may be separated from each other (e.g., along the x-z plane) by an intra-bundle spacing for example, similar to the spacing, s, described above with respect to FIG. 2A. Between bundles, adjacent cut fibers 224 can be separated by an inter-bundle spacing greater than the intra-bundle spacing, for example, less than or equal to 500 μm (e.g., in a range of 50-250 μm, inclusive). In some embodiments, the laterally-oriented fibers 226 can serve as the base or supporting layer, and the cut fibers 224 extending (e.g., along the y-direction) beyond the laterally-oriented fibers 226 can serve as projecting portions.

In some embodiments, exposed ends of the projecting portions (e.g., adjacent to the gap) can have a narrowed or tapered shape, for example, a one-dimensional tip. For example, ends of the cut fibers 224 can be sharpened to have a conical tip, which can further decrease the barrier for arc discharge. In some embodiments, the sharpening of the fiber tip can be a result of the initial plasma generation. For example, after the first plasma breakdown, due to temperature and local electrical fields, the tips of carbon fibers can gradually be sharpened to have the conical shape. Other modalities for tip sharpening are also possible according to one or more contemplated embodiments. Alternatively or additionally, in some embodiments, the projecting portions can have tips that are narrowed or tapered in only one dimension, for example, forming a two-dimensional tip (e.g., knife edge). Alternatively or additionally, in some embodiments, the projecting portions can be formed as protruding surface features of an underlying bulk part, for example, rounded or blunt tips.

In some embodiments, the projecting portions (of one or both electrodes) can be a roughened surface, for example, of an electrode member (e.g., base layer). The roughened surface can be formed, for example, by scratching a surface of the electrode member that will face the gap with a sharp object (e.g., one or more sharp tips, such as a steel needle). The scratching of the surface can be according to a regular pattern (e.g., parallel and/or orthogonal straight lines) or irregular pattern (e.g., randomly-oriented, unevenly-spaced, curved, etc.). Alternatively or additionally, the roughened surface can be formed, for example, by sanding (e.g., using coarse sand paper), grinding, sandblasting, etching, laser ablation, wire brushing, or any other technique for increasing the average roughness of a surface. In some embodiments, the roughened surface can have an average roughness (Ra) of at least 10 μm, for example, greater than or equal to 100 μm. Alternatively or additionally, the roughened surface can comprise peaks having a height of at least 100 μm and/or troughs having a depth of at least 100 μm (e.g., as measured by a profilometer).

In some embodiments, a plasma system can include means for initiating the plasma, for example, by providing a smaller distance (or even zero distance, e.g., by contacting) than the gap between electrodes such that gas discharge occurs at a lower voltage than would otherwise be possible. In some embodiments, the initiating means can be temporary, for example, removed or altered once the plasma is initiated. In some embodiments, the initiating means can be reusable or reproducible, for example, to initiate the plasma between the electrodes more than once. Alternatively, in some embodiments, the initiating means may be consumable, for example, degraded or decomposed by the high temperatures of the generated plasma.

In some embodiments, the plasma can be generated by applying voltage between the electrodes separated by a first gap, a surface of at least one of the electrodes that faces the first gap can have a plurality of first projecting portions, and a surface of at least one of the electrodes that faces the first gap can have a plurality of second projecting portions (e.g., pillars, fibers, tips, or other surface protrusions). In some embodiments, the first and second projecting portions can be on the same surface, with the second projecting portions being longer than the first projecting portions so as to extend into the first gap between the electrodes. In some embodiments, the second projecting portions form a narrower second gap with the other electrode (e.g., a surface of the other electrode facing the gap, a first projecting portion extending from the surface of the other electrode, or a second projecting portion extending from the surface of the other electrode). In some embodiments, the narrower second gap can be at least an order of magnitude smaller than the first gap and/or have a size that is within an order of magnitude of a cross-sectional dimension of the second projecting portion. In some embodiments, gas discharge can occur across the second gap at a voltage (or power) much lower than that needed to generate gas discharge across the first gap, for example, by at least an order of magnitude.

For example, FIG. 2C shows a plasma system 200 with a first electrode 202a, a second electrode 202b, an electrical power supply 128, and a controller 126. In the illustrated example, the first electrode 202a is separated from the second electrode 202b by a gap 206 (e.g., having thickness, g). In some embodiments, the gap 206 can be less than 10 cm, for example, in a range of 1 mm to 5 cm, inclusive. The first electrode 202a can have a plurality 104a of first projecting portions that extend (e.g., along the y-direction) toward the second electrode 202b, and the second electrode 202b can have its own plurality 104b of first projecting portions that extend (e.g., along the y-direction) toward the first electrode 202a. In addition, the first electrode 202a can have one or more second projecting portions 208a that extend (e.g., along the y-direction) farther than the plurality 104a of first projecting portions, and the second electrode 202b can have its own one or more second projecting portions 208b that extend (e.g., along the y-direction) farther than the plurality 104b of first projecting portions. The second projecting portions 208b of the second electrode 202b may have a configuration (e.g., shape, size, spacing, and/or material) that is the same as or different from that of the second projecting portions 208a of the first electrode 202a.

In some embodiments, the second projecting portions 208a, 208b can be disposed on or formed from a surface of the respective base layer 102a, 102b, for example, similar to but longer than pillars 116a in the top inset of FIG. 2A. Alternatively or additionally, in some embodiments, the second projecting portions 208a, 208b can be exposed or cut surface portions of the respective base layer 102a, 102b, for example, similar to but longer than fibers 116b in the bottom inset of FIG. 2A. In some embodiments, each second projecting portion 208a, 208b can have a cross-sectional dimension (e.g., a maximum or minimum cross-sectional dimension in the x-z plane, for example, a diameter) that is about the same as the cross-sectional dimension of the first projecting portions in the respective plurality 104a, 104b, for example, less than or equal to 500 μm. In some embodiments, the cross-sectional dimension for the second projecting portions 208a, 208b can be greater than 1 μm, for example, in a range of 1-100 μm, inclusive. In some embodiments, the cross-sectional dimension may represent an average of each of the second projecting portions 208a or each of the second projecting portions 208b, with the cross-sectional dimensions of the second projecting portions 208a, 208b being within 10% of the respective average.

In some embodiments, the second projecting portions 208a, 208b extend into and across gap 206 so as to initially contact each other and form high-resistance points of contact and/or to form narrow gap regions 210 (e.g., on the order of the respective cross-sectional dimension, such as ≤5 μm), which can facilitate the initiation of the plasma at a lower voltage. In some embodiments, each second projecting portion 208a, 208b can extend from the respective base layer 102a, 102b by a distance, L, along a thickness direction of the gap 206 (e.g., along the y-direction). In some embodiments, the distance, L, can be greater than or equal to 1 mm, for example, in a range of 10-100 mm, inclusive. In some embodiments, the distance, L, may represent an average across the respective electrode 202a, 202b, and the distance that each second projecting portion 208a, 208b extends along the gap thickness direction can be within 10% of the average. In some embodiments, each second projecting portion 208a, 208b can deviate from being straight along at least part of its length, and/or have a part at an angle with respect to a thickness of the gap (e.g., extending in the x-z plane), for example, as shown in FIGS. 2C-2D, in which case the distance, L, may correspond to the distance that the second projecting portion extends along the y-direction. Alternatively or additionally, in some embodiments, each second projecting portion can be substantially straight and extend substantially parallel to a thickness of the gap 206 (e.g., parallel to the y-direction), such that the distance, L, may correspond to the length of the respective second projecting portion.

In some embodiments, the contacting or narrowed gap regions 210 of the second projecting portions 208a, 208b can help initiate the plasma at a lower voltage than would otherwise be possible across gap 206. Once initiated, the plasma can grow across and be maintained by the plurality 104a of first protruding portions of the first electrode 202a and/or the plurality 104b of first protruding portions of the second electrode 202b. For example, in an initial stage, voltage can be applied across gap 206 via electrodes 202a, 202b, such that a current flows through the contacting second projecting portions 208a, 208b and causes Joule heating thereof. Because of the current flow, the second projecting portions can begin to glow, for example, without any plasma formation. The Joule heating can be intensified at defect regions or the contact points of the second projecting portions where the resistance is highest, which consequently generates a locally ultrahigh temperature (e.g., greater than a melting temperature of the second projecting portions, for example, greater than 4000 K) that causes the corresponding parts of the second projecting portions to break. This self-terminating process generates extremely narrow gaps between the second projecting portions, for example, close to the scale of the diameter of the second projecting portions (~10 μm). Because of the gap formation, current can no longer flow through the second projecting portions 208a, 208b, and the gap 206 between the first and second electrodes 202a, 202b remains dark despite increasing the voltage in a second stage.

In a third stage, further increases of the voltage may begin to produce gas discharge. For example, the locally-enhanced electric fields at the tips of the second projecting portions 208a, 208b may promote second electron emissions that result in spark discharge across the newly formed gaps, which in turn may help to initiate the plasma at a low breakdown voltage (e.g., V_{I}≤100 V, such as ~40-45 V). Once the plasma is initiated, the plasma can then grow during the fourth stage, where the densely-spaced shorter first projecting portions 104a, 104b produce tip-enhanced electric fields that merge across the surfaces of the electrodes, accelerate the Townsend breakdown to arc transition, expand the plasma size and volume, and increase the plasma uniformity, unlike conventional arc discharge. This expansion may also generate a collective heating effect that helps stabilize the plasma. As the plasma expands, the voltage drops from the breakdown voltage (with a concomitant increase in current) until the plasma reaches its volumetric plasma form, corresponding to an applied voltage, V_{P}. By continuing to apply sufficient power (e.g., 400-800 W, inclusive) between electrodes 202a, 202b, the plasma can be maintained and be stable for at least one minute (e.g., at least 10 minutes), or, in some embodiments, indefinitely depending on the plasma temperature and the materials employed in the system.

In the illustrated example of FIG. 2C, the second electrode 202b is provided as a base layer 102b with first and second projecting portions. However, in some embodiments, the second electrode may only have second projecting portions. Alternatively, in some embodiments, the second electrode may not have any projecting portions. Alternatively, in some embodiments, neither the first electrode nor the second electrode has second projecting portions. Rather, a separate trigger (e.g., wire) can be used to initiate the plasma at a lower voltage than use of the electrodes alone. In some embodiments, after initiating the plasma, the separate member may be consumed by the plasma (e.g., having a melting temperature less than that of the plasma) or removed from the plasma.

In some embodiments, instead of or in addition to providing second projecting portions and/or a separate trigger, the thickness of the gap can be changed to facilitate plasma initiation. For example, FIG. 2E illustrates part of a plasma system 230 that employs variable gap spacing between first and second electrodes. In the illustrated example, the first electrode has a base layer 102a with a plurality 104a of first projecting portions, and the second electrode has a base layer 102b with a plurality 104b of first projecting portions. However, other configurations for the first electrode and/or the second electrode are also possible according to one or more contemplated embodiments. In the illustrated example, the first electrode is mounted on or supported by a first translation stage 234a having a motor 236a, and the second electrode is mounted on or supported by a second translation stage 234b having a motor 236b. The first and second translation stages 234a, 234b can be configured to move the first and second electrodes toward or away from each other, so as to change a size of the gap therebetween. Other configurations for the first and second translation stages are also possible according to one or more contemplated embodiments, for example, using a translation stage for one of the electrodes while the other remains in a fixed location, mounting both electrodes on a common translation stage, using a translation stage that does not employ a motor, or any other means for varying the size of the gap between the electrodes.

To initiate the plasma, the first electrode (e.g., with base layer 102a and plurality 104a of first projecting portions) and the second electrode (e.g., with base layer 102b and plurality 104b of first projecting portions) can be positioned to form a gap, g₁, of a first thickness, as shown at initiation stage 240. Application of voltage across g₁ can generate gas discharge 232 between some of the first projecting portions, which can grow into a plasma 238 via the rest of the pluralities 104a, 104b of the first projecting portions. Once the plasma 238 has been generated, the first and second electrodes can be moved apart to form a gap, g₂, of a second thickness greater than that of g₁. As the electrodes are moved apart, the power applied to the electrodes can be controlled to maintain the plasma (e.g., by increasing the current and/or voltage) despite the increased size of the gap. Once a desired gap spacing has been achieved as shown at maintain stage 242, the plasma 238 can be used, for example, to provide high-intensity light for a particular application. Alternatively or additionally, the gap spacing can be varied during the usage, for example, to compensate for consumption of the electrodes and/or to maintain a desired light output.

In some embodiments, prior to plasma initiation, the voltage can be applied between the electrodes while the electrodes are moving. For example, the voltage can be applied, and the gap between electrodes progressively decreased until the plasma initiates. Once initiated, the gap between electrodes can be maintained or progressively increased until a desired gap thickness is achieved.

### Computer Implementation Examples

FIG. 2F depicts a generalized example of a suitable computing environment 531 in which the described innovations may be implemented, such as but not limited to aspects of power supply 128, controller 126, control system 124, controllers of translation stages 234a,b, power supply 314, controller 316, electrical supply or generation device 318, control system 312, controllers of translation devices 612a, 612b, etc., The computing environment 531 is not intended to suggest any limitation as to scope of use or functionality, as the innovations may be implemented in diverse general-purpose or special-purpose computing systems. For example, the computing environment 531 can be any of a variety of computing devices (e.g., desktop computer, laptop computer, server computer, tablet computer, etc.).

With reference to FIG. 2F, the computing environment 531 includes one or more processing units 535, 537 and memory 539, 541. In FIG. 2F, this basic configuration 551 is included within a dashed line. The processing units 535, 537 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 2F shows a central processing unit 535 as well as a graphics processing unit or co-processing unit 537. The tangible memory 539, 541 may be volatile memory (e.g., registers, cache, RAM), non-volatile memory (e.g., ROM, EEPROM, flash memory, etc.), or some combination of the two, accessible by the processing unit(s). The memory 539, 541 stores software 533 implementing one or more innovations described herein, in the form of computer-executable instructions suitable for execution by the processing unit(s).

A computing system may have additional features. For example, the computing environment 531 includes storage 561, one or more input devices 571, one or more output devices 581, and one or more communication connections 591. An interconnection mechanism (not shown) such as a bus, controller, or network interconnects the components of the computing environment 531. Typically, operating system software (not shown) provides an operating environment for other software executing in the computing environment 531, and coordinates activities of the components of the computing environment 531.

The tangible storage 561 may be removable or non-removable, and includes magnetic disks, magnetic tapes or cassettes, CD-ROMs, DVDs, or any other medium which can be used to store information in a non-transitory way, and which can be accessed within the computing environment 531. The storage 561 can store instructions for the software 533 implementing one or more innovations described herein.

The input device(s) 571 may be a touch input device such as a keyboard, mouse, pen, or trackball, a voice input device, a scanning device, or another device that provides input to the computing environment 531. The output device(s) 581 may be a display, printer, speaker, CD-writer, or another device that provides output from computing environment 531.

The communication connection(s) 591 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Reconfigurable Plasma Systems for Generating Light

FIG. 3A illustrates a plasma system 300 having a pair of electrodes 302a, 302b separated by a gap. In the illustrated example, each electrode 302a, 302b includes an electrode layer 306a, 306b adjacent to the gap and coupled to a respective support member 304a, 304b. In some embodiments, one or both of the electrode layers 306a, 306b can comprise projecting portions (e.g., fibers), and one or both of the electrode layers 306a, 306b (e.g., carbon) can be formed of a different material than the respective support member 304a, 304b (e.g., graphite). In some embodiments, each electrode layer 306a, 306b can be coupled to the respective support member 304a, 304b, for example, via an appropriate adhesive (e.g., capable of retaining the electrode layer 306 to the support member 304 despite prolonged exposure to temperatures in excess of 1000 K).

In the illustrated example, the plasma system 300 also includes a control system 312, which can comprise a power supply 314 and a controller 316. The power supply 314 can be operatively coupled to the electrodes 302a, 302b and configured to apply a voltage and/or current thereto so as to generate plasma 322, which in turn produces broadband light 324. The controller 316 can be operatively coupled to the power supply 314 to control operation thereof, for example, to control generation of the plasma and/or characteristics thereof. In some embodiments, the power supply 314 and/or control system 312 can comprise an electrical ballast, for example, to help initiate plasma 322. In some embodiments, the control system 312 can control the plasma current to tune the intensity of light 324, where higher currents correspond to higher light intensities, as reflected by the data in FIG. 3C. Moreover, the light intensity can rapidly respond to changes in the plasma current, thereby allowing the control system 312 to quickly and precisely control the light intensity for a desired application.

In some embodiments, the plasma system 300 can optionally include an electricity supply or generation device, such as device 318 in FIG. 3A, which may allow the plasma system 300 to operate as an independent or portable light source. For example, electricity supply or generation device 318 can comprise an electrochemical battery (e.g., primary or secondary battery, such as a lithium ion battery), capacitor, or other electricity storage means. Alternatively or additionally, electricity supply or generation device 318 can generate electricity, for example, via a solar cell (e.g., photovoltaic), mechanical energy harvesting (e.g., piezoelectric), fuel cell, etc.

In the illustrated example, the controller 316 may also be operatively coupled to translation stages 308a, 308b with respective motors 310a, 310b, which can move the electrodes 302a, 302b toward or away from each other to change a size of the gap therebetween. In some embodiments, a sensor 320 (e.g., optical sensor) can be detect one or more characteristics (e.g., intensity, spectra, etc.) of the generated light 324, and the controller 316 can control operation of the plasma system 300 responsively thereto. For example, in some embodiments, the controller 316 can control translation stages 308a, 308b and/or change a power applied to the electrodes 302a, 302b to adjust the gap to initiate the plasma, expand the plasma, change or maintain a desired intensity for light 324 (e.g., as measured by sensor 320), and/or compensate for electrode layer degradation or consumption, as described in more detail below.

For example, FIG. 3B illustrates operation of a plasma system with gap adjustment. At a first time 330, the electrode layers 332a, 332b can be spaced apart by a gap of thickness g1 and a plasma can be generated within the gap. Over time, however, the electrode layers may be consumed or degraded by the plasma operation, such that a size of the degraded electrode layers 336a, 336b is less and/or a thickness of the gap increases, e.g., to a thickness g2 as shown at second time 334. For example, the electrode layers can be consumed or degraded when the light source is operated without a gas containment vessel (e.g., in an atmosphere containing oxygen and the degradation is due at least in part to oxidation of the electrodes). This change in gap thickness may alter the characteristics of the plasma (e.g., lower temperature and/or intensity) and/or light, and/or may require changes in applied power to maintain the same characteristics of the plasma and/or light. In some embodiments, one or both of the electrodes can be moved toward the other to compensate for the degraded electrode layers 336a, 336b and corresponding change in gap thickness, for example, to revert to the original thickness g1, as shown at third time 338. In some embodiments, the electrode movement can be performed continuously, for example, at a rate substantially corresponding to that at which the electrode layers are consumed so as to maintain the gap thickness at a substantially constant thickness. Alternatively, in some embodiments, the electrode movement can be performed periodically, for example, when a gap thickness exceeds a predetermined threshold and/or when plasma and/or light characteristics are outside a predetermined range.

FIG. 3D illustrates another operation of a plasma system with gap adjustment. At a first time 340, the electrode layers 342a, 342b can be disposed without a gap therebetween. A current can be flowed through the electrode layers 342a, 342b (e.g., from the top electrode layer 342a to the bottom electrode layer 342b, or vice versa), for example, by applying a first voltage (e.g., less than 24 V, such as 19-21 V, inclusive). The current flowing through the electrode layers can cause Joule heating thereof. The Joule heating may increase the temperature of the electrode layers and surrounding area, which may help subsequently initiate the plasma at the second time 344. In some embodiments, one or both of the electrodes can be moved away from the other to produce a gap and/or increase a size of the gap, while the first voltage is applied. With the gap at a thickness of g3, the light source has thus transitioned from the Joule heating of the first time 340 to production of a limited plasma 346 (e.g., having a lateral area less than that of the electrode layer, for example, less than 1-cm diameter) at the second time 344. In some embodiments, the limited plasma can be expanded and/or the gap thickness increased (e.g., with g4≥g3) for subsequent use as a light source. For example, the limited plasma 346 at the second time 344 can be expanded to a volumetric plasma 350 covering the full area of the electrode layers 342a, 342b (e.g., at least 1-inch in diameter) at the third time 348 by increasing to the applied voltage to a second voltage (e.g., greater than 24 V, such as 27-29 V, inclusive) greater than the first voltage. Operation of a fabricated system according to FIG. 3D is shown in FIG. 3E, where during a first stage 362 the electrode layers are in contact and experience Joule heating, during a second stage 364 the electrode layers are moved apart and a limited plasma is generated, and during a third stage 366 the plasma is expanded by increasing the voltage.

In the example of FIG. 3D, the electrode layers 342a, 342b are illustrated as separate layers disposed with facing surfaces in contact with each other at the first time 340. Alternatively, in some embodiments, the electrode layers can be different parts of a single contiguous layer. For example, the single electrode layer may be coupled (e.g., via adhesive) to both support members at the first time 340, and the movement of the electrodes away from each other can pull the single layer apart, thereby forming separate electrode layer pieces with a gap therebetween, similar to configuration at the second time 344 in FIG. 3D.

Plasma Systems with Light Altering Assemblies

In some embodiments, light from the plasma system can be redirected, focused, filtered, and/or patterned for use in a particular application, for example, via one or more optical elements. Alternatively or additionally, the plasma system can comprise one or more optical elements for redirecting, focusing, filtering, and/or patterning the light for use in a particular application. Such optical elements can include, but are not limited to, reflective elements (e.g., mirrors, gratings, etc.), refractive elements (e.g., lenses, gratings, etc.), spheres (e.g., integrating sphere, focusing sphere), filters (e.g., dichroic, short-pass, long-pass, bandpass, neutral density, etc.), photomasks, optical chopper (e.g., rotating disk, tuning fork, shutter), etc.

For example, FIG. 4A illustrates a plasma system 400 with a pair of electrodes 402a, 402b separated by a gap, where light 406 from the generated plasma 404 within the gap can be directed or collimated by concave mirror 408. Although a single mirror with a particular curvature is shown in FIG. 4A, other reflective element configurations and/or numbers of reflective elements are also possible according to one or more contemplated embodiments. For example, FIG. 4B illustrate another plasma system 410 with a pair of electrodes (only top electrode 412 shown in the top-down view of FIG. 4B) separated by a gap, where light 416 from the generated plasma 414 can be directed or collimated by U-shaped mirror 418 (e.g., have an axis of curvature extending parallel to a thickness of the gap between electrodes).

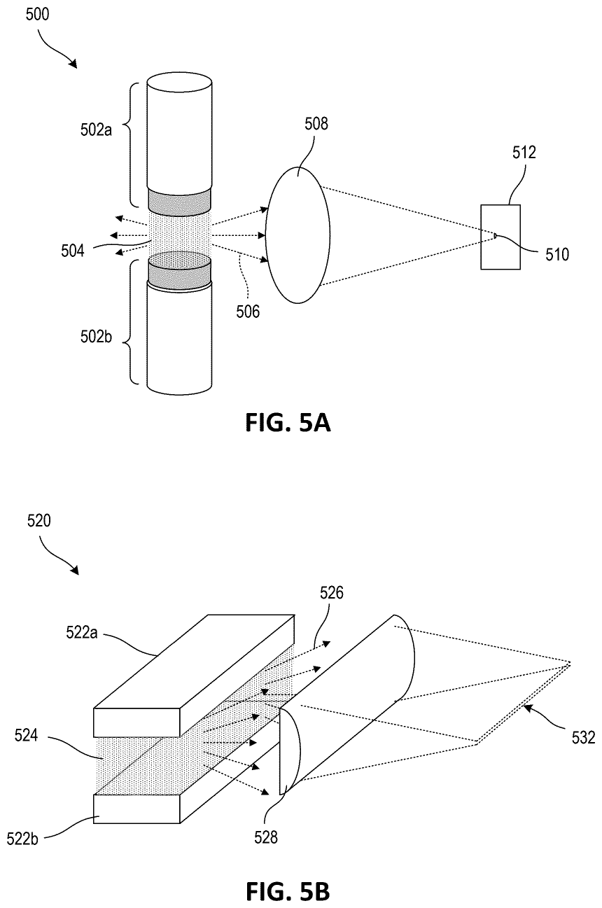

FIG. 5A illustrates a plasma system 500 with a pair of electrodes 502a, 502b separated by a gap, where light 506 from the generated plasma 504 within the gap can be directed or focused by a lens 508 (e.g., convex lens), for example, to a focal spot 510 on a target 512. In some embodiments, the focusing of the high-intensity light can be used to heat the focal spot to high temperatures, for example, to perform sintering, welding, brazing, etc. Other means for focusing the light are also possible according to one or more contemplated embodiments. Moreover, although FIG. 5A illustrates focusing of the light to a spot, other focal shapes and sizes are also possible. For example, FIG. 5B illustrates another plasma system 520 with a pair of electrodes 522a, 522b separated by a gap, where light 526 from the generated plasma 524 can be directed or focused by lens 528 (e.g., cylindrical lens) to form a line or rectangle 532.

In some embodiments, the plasma system can be disposed within an enclosure or housing (e.g., gas containment vessel), for example, to prevent, or at least reduce, exposure of the electrodes to gases (e.g., oxygen) that could otherwise degrade (or accelerate degradation) of the electrodes over time. Alternatively or additionally, in some embodiments, the enclosure or housing can receive and/or discharge a gas (e.g., inert gas), for example, to assist in the formation of the plasma, to dissipate heat generated by the plasma, and/or remove or mitigate products of electrode degradation (e.g., carbon emission, carbon black deposition, etc.), especially where long-term operation (e.g., months or years) may be desirable.

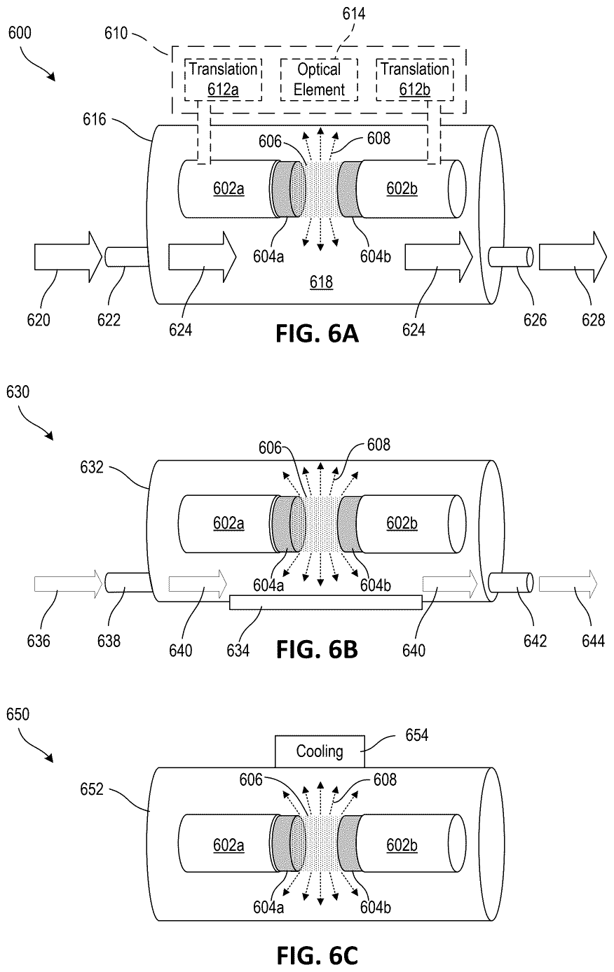

For example, FIG. 6A illustrates a plasma system 600 with a pair of electrodes disposed in an interior volume of a housing 616, which has an inlet 622 for a gas inlet flow 620 and an outlet 626 for a gas outlet flow 628. In the illustrated example, each electrode comprises an electrode layer 604a, 604b coupled to a respective support member 602a, 602b, and a plasma 606 can be generated in the gap between electrode layers 604a, 604b. In some embodiments, at least part of the housing 616 may be transparent, such that light 608 from the plasma 606 can be emitted therethrough for a particular use. In the illustrated example, the system 600 also includes an adaptation module 610, which comprises one or more translation devices 612a, 612b configured to move the electrodes within the housing 616 (e.g., to maintain a size of the gap) and/or one or more optical elements 614 configured to interact with light 608. Although components of the adaptation module 610 are shown as disposed outside the housing 616 in FIG. 6A, in some embodiments, some or all of the components of the adaptation module 610 can be disposed within or coupled to the housing 616.

In some embodiments, the inlet flow 620 can enter the interior volume 618 and can form an internal gas flow 624 that can carry off debris (e.g., resulting from electrode degradation and/or plasma generation) and/or heat (e.g., to cool the electrodes and/or the housing) via outlet flow 628. The inlet flow 620 and/or outlet flow 628 can be periodic or continuous, and/or their flow rates can be adjusted responsively to detected conditions (e.g., when debris is degrading transmission of light 608 through the housing 616). In some embodiments, the inlet flow 620 is or comprises an inert gas. Although a particular flow pattern, number of ports, and inlet/outlet arrangement are illustrated in FIG. 6A, embodiments of the disclosed subject matter are not limited thereto. Rather, other flow patterns, numbers of ports, and/or inlet/outlet arrangements are also possible according to one or more contemplated embodiments. For example, the inlet 622 and/or the outlet 626 can be arranged so as to induce a vortical flow pattern for internal gas flow 624.

Alternatively or additionally, the flow pattern can be directed with respect to a transparent portion of the housing through which light 608 has to pass, for example, to preferentially remove debris from the transparent portion. For example, FIG. 6B illustrates another plasma system 630 with a pair of electrodes disposed within housing 632. In the illustrated example, housing 632 has a transparent window 634 through which light 608 passes, while the remainder of the housing may be substantially opaque with respect to light 608. Housing 632 may also include an inlet 638 for a gas inlet flow 636 and an outlet 642 for a gas outlet flow 644. For example, the inlet flow 636 can enter the housing 632 via inlet 638 and can form an internal gas flow 640 that sweeps across the internal face of window 634 so as to remove debris therefrom.

As noted above, in some embodiments, the gas flow through the housing may remove heat generated by the plasma, for example, to cool the electrodes and/or the housing. Alternatively or additionally, in some embodiments, a cooling module can be provided, for example, as part of the housing, or at least in thermal communication with the housing. For example, FIG. 6C illustrates a plasma system 650 having a cooling module 654 thermally coupled to the housing 652. In some embodiments, the cooling module 654 can comprise one or more passive cooling features (e.g., heat sinks thermally coupled to the housing, etc.), one or more active cooling features (e.g., fluid flow directed at the sintered structures and/or the heater, fluid flow through a heat sink thermally coupled thereto, etc.), or any combination thereof. In the illustrated example of FIG. 6C, the cooling module 654 is disposed outside the internal volume of the housing; however, in some embodiments, the cooling module may be disposed inside the internal volume of the housing, for example, proximal to or in contact with the electrodes.

### Exemplary Uses of Light Generated by Plasma Systems

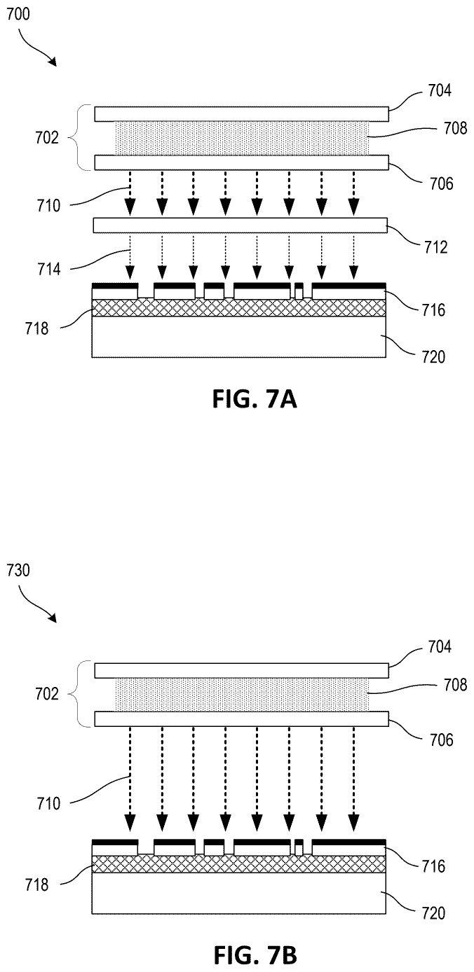

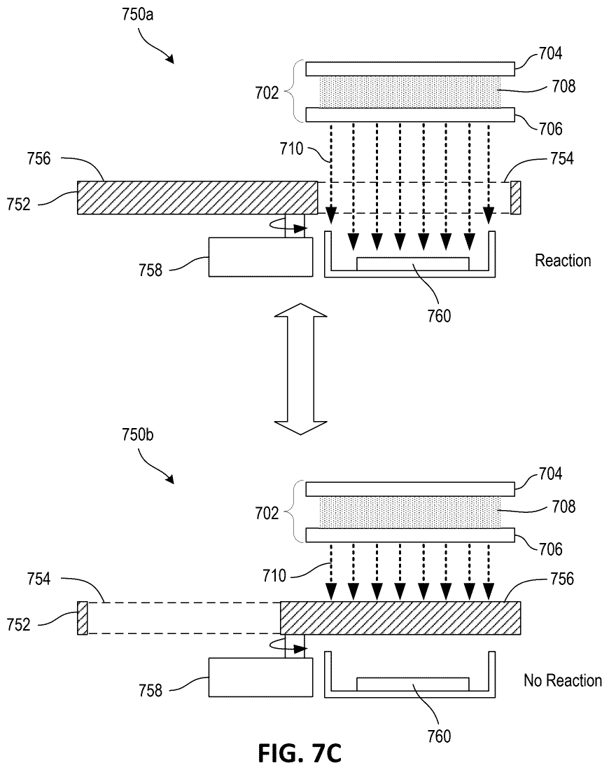

FIG. 7A illustrates a configuration 700 for use of light from a plasma system 702, for example, as a broadband light source for photolithography (e.g., for manufacturing of semiconductors, microelectromechanical systems (MEMS), microfluidic devices, etc.). In the illustrated example, the plasma system 702 has a pair of electrodes 704, 706, between which a volumetric plasma 708 can be generated. The light 710 resulting from the plasma 708 can pass through one or more bandpass filters 712 to produce light 714 having a desired wavelength (e.g., depending on the photoresist 718 employed and the pattern feature size, for example, having a wavelength in the extreme UV (~13.5 nm) or deep UV (~193 nm) regimes). The filtered light 714 may then pass through the pattern of a photomask 716 en route to a substrate 720 (e.g., semiconductor wafer) coated with photoresist 718 (e.g., positive or negative). The light 714 exposes the photoresist 718, thereby transferring the pattern of the photomask 716 onto the photoresist 718, which can then be used as a template for further manufacturing (e.g., etching of the underlying substrate, deposition of material, ion implantation of the underlying substrate, etc.) Other configurations are also possible for performing photolithography using the plasma light source according to one or more contemplated embodiments. For example, FIG. 7B illustrates another configuration 730 where the light 710 from the plasma system 702 directly irradiates the photomask 716 without any intermediate filtering for wavelength selection.

FIG. 7C illustrates another example for use of light from a plasma system 702, for example, as a broadband light source for initiating, controlling, and/or driving a chemical reaction (e.g., a photo-induced reaction and/or heating process). In some embodiments, the reaction can proceed when the sample 760 is illuminated with light 710 from the plasma system 702, but the reaction may stop when the sample 760 is not illuminated with light 710 from the plasma system 702. For example, photons in the light 710 can be directly utilized to drive photocatalytic reactions and/or photo-electrocatalytic reactions by irradiating semiconductors, polymers, ceramics, and/or metallic materials. Alternatively or additionally, photothermal materials (e.g., noble metals, carbon-based structures, and/or polymers) can be irradiated, and the light energy can be converted to thermal energy to drive various reactions, such as but not limited to vapor generation, photothermal therapy, photodynamic therapy, power generation, heating, etc.

In the illustrated example of FIG. 7C, a mechanical chopper 752 is used to switch between illuminated state 750a and non-illuminated state 750b. For example, an actuator 758 (e.g., rotary motor or linear drive) can be used to switch the mechanical chopper 752 between the illuminated state 750a, where light 710 is transmitted to sample 760 via first portion 754 (e.g., a transparent portion of or opening in chopper 752), and the non-illuminated state 750b, where light 710 is prevented from reaching sample 760 via second portion 756 (e.g., an opaque or reflective portion of chopper 752). Alternatively or additionally, switching between illuminated and non-illuminated states can be controlled by adjusting characteristics of the plasma 708, for example, by controlling the applied current to switch the plasma between on and off states. In some embodiments, additional optical elements (e.g., filters) can be provided to modify the light, for example, disposed in the optical path between the plasma system 702 and the chopper 752 and/or between the chopper 752 and the sample 760.

### Fabricated Examples and Experimental Results

High-intensity, white light was generated by a plasma light source having 25-mm diameter carbon felt electrodes. The plasma and resulting light were stable for more than 10 minutes. The light spectra in FIG. 3C were collected using the plasma light source with 25-mm diameter carbon felt electrodes.

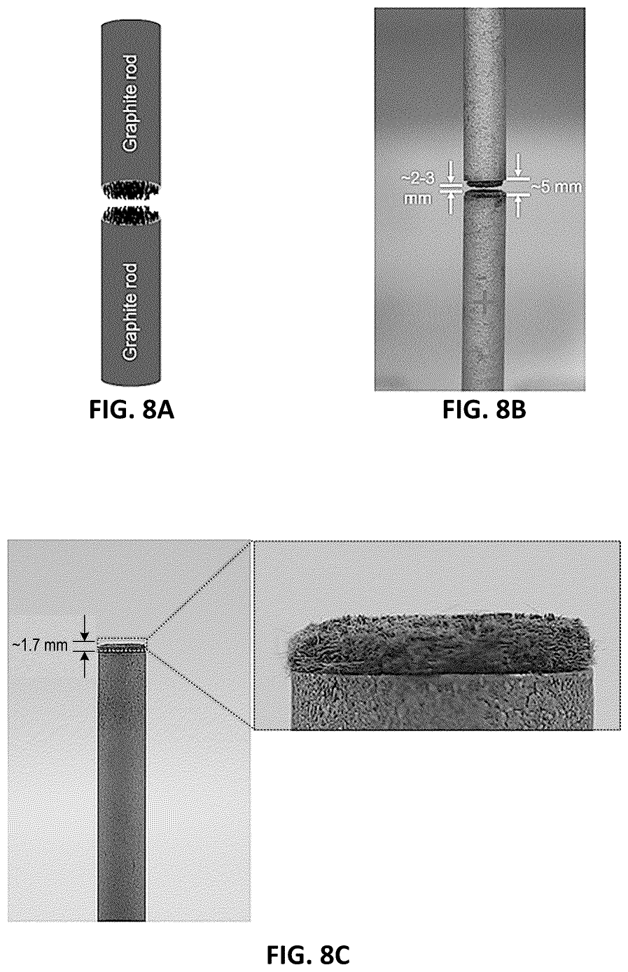

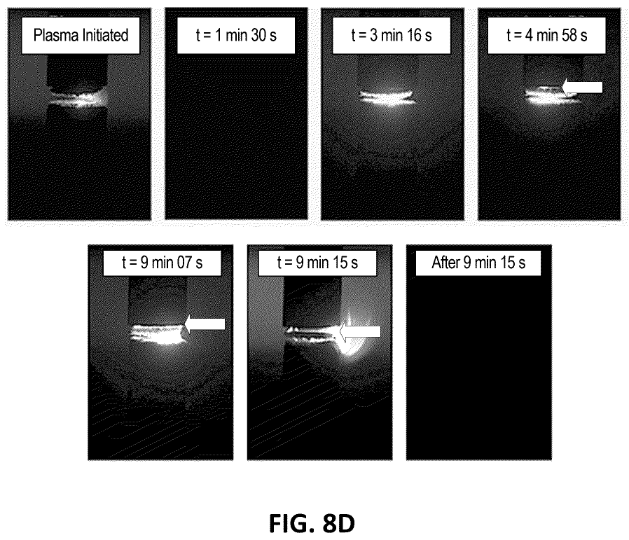

To reduce the current required and/to make the plasma light source more portable (e.g., for application such as blinding), smaller diameter electrodes were used. For example, experiments were performed using electrodes with 10-mm carbon felt. Two graphite electrodes (10-mm in diameter) were topped (e.g., using an adhesive) with a layer of carbon felt with a thickness of 1.7 mm. The electrodes were vertically aligned and separated by a gap of ~2-3 mm, as shown in FIGS. 8A-8B. The carbon felt was composed of vertically oriented carbon fibers, as shown in FIG. 8C. The top electrode was connected to a stand equipped with sliding rail to adjust the gap distance. In the experiment, plasma was initiated with applied power. The breakdown voltage was recorded as 59.6 V. After plasma initiation, the current was kept at about 5.65 A and the voltage was recorded as ~18 V. FIG. 8D shows images of different stages after plasma initiation that were taken from a recorded video of 12 minutes, 18 seconds.

In the experiment, the plasma was initially sustained for only about 1 minute, 30 seconds. At the 3 minutes, 16 second mark after start of the experiment, the cathode was slightly lowered in an attempt to re-initiate the plasma. Due to the stability of the carbon felt and low plasma control current (about 5.65 A), the consumption rate of the carbon felt was slow and the plasma can normally be sustained for an extended time. However, at 4 minutes, 58 seconds, a crack was observed at the interface between the graphite electrode and the carbon felt (indicated by the arrow in FIG. 8D). This defect can be attributed to the decomposition of the glue due to extended exposure to the high temperatures of the plasma, which defect can be avoided or at least mitigated in some embodiments by appropriate selection of coupling materials. The crack became more apparent at 9 minutes, 07 seconds. At 9 minutes, 15 seconds, the carbon felt on the cathode fell from the graphite rod which immediately resulted in plasma fluctuations. Despite waiting for another 3 minutes, the plasma could not be re-initiated, and the experiment was ended at 12 minutes, 18 seconds. During the entire process, no hot anode was observed as the gap distance was maintained more than 1 mm.

In another experiment, carbon felt was cut into 10-mm diameter round disks, and each carbon felt disk was embedded in a larger diameter graphite base. A pair of the electrodes was vertically aligned and separated by a gap of ~2 mm between the exposed carbon felt disks. The plasma was maintained for at least 10 minutes with an applied current of about 36 A and an applied voltage of about 21 V, during which time high-intensity light was emitted. After operation, the carbon felt disks showed effects of consumption (especially the anode). In some embodiments, the plasma can be maintained for more than 10 minutes using a lower applied current (e.g., ≤5 A), which in turn can result in a lower consumption rate of the electrodes (e.g., carbon felt) at a lower plasma temperature.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method comprising:
generating a volumetric plasma using a pair of electrodes spaced apart from each other by a gap along a first direction, at least one of the pair of electrodes comprising a plurality of first projecting portions that extend along the first direction toward the other electrode of the pair, each electrode comprising a material having a melting temperature of at least 1000 K, the generated volumetric plasma producing broadband light; and
using at least a portion of the broadband light.

Clause 2. The method of any clause or example herein, in particular, Clause 1, wherein the using comprises:
sintering, welding, or brazing by focusing the at least a portion of the broadband light;
illuminating an area or an object;
offering deterrence or defense by blinding of a person or light sensor; or
any combination of the foregoing.

Clause 3. The method of any clause or example herein, in particular, any one of Clauses 1-2, wherein, during the generating, a temperature of the volumetric plasma is in a range of 1,000-10,000 K.

Clause 4. The method of any clause or example herein, in particular, any one of Clauses 1-3, wherein:
each of the first projecting portions has a maximum cross-sectional dimension in a plane substantially perpendicular to the first direction less than or equal to 500 μm;
each of the first projecting portions has a length along the first direction less than or equal to 1 cm;
each of the first projecting portions is spaced from adjacent ones of the plurality of first projecting portions by less than or equal 1 mm; or
any combination of the above.

Clause 5. The method of any clause or example herein, in particular, any one of Clauses 1-4, wherein a peak voltage applied between the pair of electrodes during the generating is less than or equal to 100 V and/or a peak current between the pair of electrodes during the generating is less than or equal to 100 A.

Clause 6. The method of any clause or example herein, in particular, any one of Clauses 1-5, further comprising:
(a) prior to the generating the volumetric plasma, providing the pair of electrodes without any gap along the first direction;
(b) applying a voltage between the pair of electrodes such that current flows through and causes Joule heating of at least a portion of the electrodes; and
(c) after or during (b), moving one or both of the pair of electrodes along the first direction so as to form the gap for initiating a plasma therein.

Clause 7. The method of any clause or example herein, in particular, any one of Clauses 1-6, wherein the generating comprises:
initiating the plasma by applying a first direct current (DC) voltage, a first alternating current (AC) voltage, or a first pulsed voltage waveform between the pair of electrodes; and
maintaining or expanding the initiated plasma by applying a second DC voltage, a second AC voltage, or a second pulsed voltage waveform between the pair of electrodes,
wherein an absolute value of a peak voltage of the second DC voltage, the second AC voltage, or the second pulsed voltage waveform is less than an absolute value of a peak voltage of the first DC voltage, the first AC voltage, or the first pulsed voltage waveform.

Clause 8. The method of any clause or example herein, in particular, any one of Clauses 1-7, wherein a size of the generated plasma along a second direction is in range of 1 mm to 100 cm, inclusive, the second direction being in a plane substantially perpendicular to the first direction.

Clause 9. The method of any clause or example herein, in particular, any one of Clauses 1-8, wherein:
one or both of the pair of electrodes comprise or is formed of carbon or graphite;
one or both of the pair of electrodes comprise or is formed of a refractory metal, a refractory metal alloy, or both of the foregoing; or
one or both of the pair of electrodes comprise or is formed of a metal carbide, a silicon carbide, a metal nitride, a metal diboride, or any combination of the foregoing.

Clause 10. The method of any clause or example herein, in particular, any one of Clauses 1-9, wherein, during the generating, at least part of one or both electrodes of the pair is degraded or consumed.

Clause 11. The method of any clause or example herein, in particular, Clause 10, further comprising, during or after the generating, moving one or both electrodes of the pair along the first direction so as to compensate for the consumed part and/or maintain a size of the gap.

Clause 12. The method of any clause or example herein, in particular, any one of Clauses 1-11, wherein:
the at least one of the pair of electrodes comprises a support member to which the plurality of first projecting portions is mounted or coupled; and/or
the at least one of the pair of electrodes comprises a base member, the plurality of first projecting portions being integral with and extending from the base member.

Clause 13. The method of any clause or example herein, in particular, Clause 12, wherein the plurality of first projecting portions comprise fibers of a felt or cloth layer.

Clause 14. The method of any clause or example herein, in particular, Clause 12, wherein the plurality of first projecting portions are formed by a cut or roughened surface of the base member.

Clause 15. The method of any clause or example herein, in particular, any one of Clauses 1-11, wherein the plurality of first projecting portions comprises aligned or twisted fibers of a fiber yarn, fiber bundle, or fiber strand.

Clause 16. The method of any clause or example herein, in particular, any one of Clauses 1-15, wherein the other of the pair of electrodes is formed of a conductive material having a substantially flat surface facing the gap.

Clause 17. The method of any clause or example herein, in particular, any one of Clauses 1-16, wherein the generating comprises using a ballast to initiate the volumetric plasma.

Clause 18. The method of any clause or example herein, in particular, any one of Clauses 1-17, wherein, during the generating:
intensities of the broadband light at wavelengths in a range of 500-800 nm, inclusive, are greater that an intensity of the broadband light at a wavelength of about 450 nm; and/or
an intensity of the broadband light at wavelengths in a range of 500-800 nm is at least 1000 W/m².

Clause 19. The method of any clause or example herein, in particular, any one of Clauses 1-18, wherein the using comprises redirecting, focusing, filtering, and/or patterning the broadband light using one or more optical elements.

Clause 20. The method of any clause or example herein, in particular, Clause 19, wherein the one or more optical elements comprise a mirror, a grating, an integrating sphere, a focusing sphere, a lens, a filter, a photomask, and/or a mechanical chopper.

Clause 21. The method of any clause or example herein, in particular, any one of Clauses 1-20, wherein the pair of electrodes are enclosed within an interior volume of a housing, and the method further comprises flowing one or more gases through at least part of the interior volume.

Clause 22. The method of any clause or example herein, in particular, any one of Clauses 1-20, wherein the pair of electrodes are disposed within a housing having a window through which the at least a portion of the broadband light can pass, and the method further comprises flowing one or more gases across and/or proximal to the window.

Clause 23. The method of any clause or example herein, in particular, any one of Clauses 21-22, wherein the one or more gases is or comprises an inert gas.

Clause 24. The method of any clause or example herein, in particular, any one of Clauses 21-23, wherein:
the flowing one or more gases is effective to cool at least a portion of the housing and/or one or both of the pair of electrodes; and/or
the flowing one or more gases is effective to remove debris resulting from the generating the volumetric plasma.

Clause 25. The method of any clause or example herein, in particular, any one of Clauses 1-24, further comprising cooling the pair of electrodes or an environment surrounding the pair of electrodes.

Clause 26. A system configured to perform the method of any clause or example herein, in particular, any one of Clauses 1-25.

Clause 27. The system of any clause or example herein, in particular, Clause 26, comprising:
an electrical power source electrically coupled to the electrodes; and
a control system operatively coupled to the electrical power source and configured to control operation thereof, the control system comprising one or more processors and computer-readable storage media storing instructions that, when executed by the one or more processors, cause the electrical power source to apply voltage between the electrodes such that the volumetric plasma is generated.

Clause 28. A system comprising:
a plasma light source comprising a pair of electrodes spaced apart from each other by a gap along a first direction, at least one of the pair of electrodes comprising a plurality of first projecting portions that extend along the first direction toward the other electrode of the pair, each electrode comprising a material having a melting temperature of at least 1000 K;
an electrical power source electrically coupled to the plasma light source; and
a control system operatively coupled to the electrical power source and configured to control operation thereof, the controller comprising one or more processors and computer-readable storage media storing instructions that, when executed by the one or more processors, cause the electrical power source to apply voltage between the pair of electrodes such that a volumetric plasma is generated,
wherein the generated volumetric plasma produces broadband light and has a temperature in a range of 1,000-10,000 K, inclusive.

Clause 29. The system of any clause or example herein, in particular, Clause 28, further comprising a portable energy storage device configured to supply stored electricity to the electrical power source and/or the control system.

Clause 30. The system of any clause or example herein, in particular, Clause 29, wherein the portable energy storage device comprises a primary battery or a secondary battery.

Clause 31. The system of any clause or example herein, in particular, any one of Clauses 28-30, further comprising a ballast coupled to the plasma light source and configured to initiate the volumetric plasma.

Clause 32. The system of any clause or example herein, in particular, any one of Clauses 28-31, further comprising one or more optical elements configured to redirect, focus, filter, and/or pattern the broadband light.

Clause 33. The system of any clause or example herein, in particular, Clause 32, wherein the one or more optical elements comprise a mirror, a grating, an integrating sphere, a focusing sphere, a lens, a filter, a photomask, and/or a mechanical chopper.

Clause 34. The system of any clause or example herein, in particular, any one of Clauses 28-33, wherein:
the plasma light source further comprises a housing in which the pair of electrodes is disposed; and
the system further comprises means for removing debris resulting from the generating the volumetric plasma and/or means for cooling.

Clause 35. The system of any clause or example herein, in particular, Clause 34, wherein the means for removing debris and/or the means for cooling comprises a flow of one or more gases through at least part of the housing.

Clause 36. The system of any clause or example herein, in particular, Clause 34, wherein the housing comprises a window through which at least a portion of the broadband light can pass, and the means for removing debris and/or the means for cooling comprises a flow of one or more gases across and/or proximal to the window.

Clause 37. The system of any clause or example herein, in particular, any one of Clauses 35-36, wherein the one or more gases comprises an inert gas.

Clause 38. The system of any clause or example herein, in particular, any one of Clauses 28-37, wherein each of the electrodes of the pair has respective first projecting portions.

Clause 39. The system of any clause or example herein, in particular, any one of Clauses 28-38, wherein:
each of the first projecting portions has a maximum cross-sectional dimension in a plane substantially perpendicular to the first direction less than or equal to 500 μm;
each of the first projecting portions has a length along the first direction less than or equal to 1 cm;
each of the first projecting portions is spaced from adjacent ones of the plurality of first projecting portions by less than or equal 1 mm; or
any combination of the above.

Clause 40. The system of any clause or example herein, in particular, any one of Clauses 28-39, wherein:
one or both of the pair of electrodes comprise or is formed of carbon or graphite;
one or both of the pair of electrodes comprise or is formed of a refractory metal, a refractory metal alloy, or both of the foregoing; or
one or both of the pair of electrodes comprise or is formed of a metal carbide, a silicon carbide, a metal nitride, a metal diboride, or any combination of the foregoing.

Clause 41. The system of any clause or example herein, in particular, any one of Clauses 28-40, wherein:
the at least one of the pair of electrodes comprises a support member to which the plurality of first projecting portions is mounted or coupled; and/or
the at least one of the pair of electrodes comprises a base member, the plurality of first projecting portions being integral with and extending from the base member.

Clause 42. The system of any clause or example herein, in particular, Clause 41, wherein:
the plurality of first projecting portions are fibers of a felt or cloth layer; and/or
the plurality of first projecting portions are formed by a cut or roughened surface of the base member.

Clause 43. The system of any clause or example herein, in particular, any one of Clauses 28-42, wherein the plurality of first projecting portions comprises aligned or twisted fibers of a fiber yarn, fiber bundle, or fiber strand.

Clause 44. The system of any clause or example herein, in particular, any one of Clauses 28-43, wherein the other of the pair of electrodes is formed of a conductive material having a substantially flat surface facing the gap.

Clause 45. The system of any clause or example herein, in particular, any one of Clauses 28-44, wherein the plasma light source further comprises one or more translation devices constructed to move one or both electrodes of the pair along the first direction.

### CONCLUSION

Any of the features illustrated or described herein, for example, with respect to FIGS. 1-8D and/or Clauses 1-45, can be combined with any other feature illustrated or described herein, for example, with respect to FIGS. 1-8D and/or Clauses 1-45, to provide systems, devices, structures, methods, examples, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. Applicant therefore claims all that comes within the scope and spirit of these claims.

1. A method comprising:
generating a plasma using a pair of electrodes spaced apart from each other by a gap along a first direction, at least one of the pair of electrodes comprising a plurality of first projecting portions that extend along the first direction toward the other electrode of the pair, each electrode comprising a material having a melting temperature of at least 1000 K, the generated plasma producing light; and
using at least a portion of the light.

2. The method of claim 1, wherein the using comprises:
sintering, welding, or brazing by focusing the at least a portion of the light;
illuminating an area or an object;
offering deterrence or defense by blinding of a person or light sensor; or
any combination of the foregoing.

3. The method of claim 1, further comprising:
(a) prior to the generating the plasma, providing the pair of electrodes without any gap along the first direction;
(b) applying a voltage between the pair of electrodes such that current flows through and causes Joule heating of at least a portion of the electrodes; and
(c) after or during (b), moving one or both of the pair of electrodes along the first direction so as to form the gap for initiating a plasma therein.

4. The method of claim 1, wherein:
during the generating, at least part of one or both electrodes of the pair is degraded or consumed; and
the method further comprises, during or after the generating, moving one or both electrodes of the pair along the first direction so as to compensate for the consumed part and/or maintain a size of the gap.

5. The method of claim 1, wherein the generating comprises using a ballast to initiate the plasma.

6. The method of claim 1, wherein an intensity of the light at wavelengths in a range of 500-800 nm is at least 1000 W/m² during the generating.

7. The method of claim 1, wherein the using comprises redirecting, focusing, filtering, and/or patterning the light using one or more optical elements.

8. The method of claim 1, wherein the pair of electrodes are disposed within an interior volume of a housing, and the method further comprises flowing one or more gases through at least part of the interior volume.

9. The method of claim 8, wherein the flowing one or more gases cools at least a portion of the housing and/or one or both of the pair of electrodes.

10. The method of claim 1, wherein the pair of electrodes are disposed within a housing having a window through which the at least a portion of the light passes, and the method further comprises flowing one or more gases across and/or proximal to the window.

11. The method of claim 10, wherein the flowing one or more gases removes debris resulting from generating the plasma.

12. A system comprising:
a pair of electrodes spaced apart from each other by a gap along a first direction, at least one of the pair of electrodes comprising a plurality of first projecting portions that extend along the first direction toward the other electrode of the pair, each electrode comprising a material having a melting temperature of at least 1000 K;
an electrical power source electrically coupled to the pair of electrodes; and
a control system operatively coupled to the electrical power source and configured to control operation thereof, the controller comprising one or more processors and computer-readable storage media storing instructions that, when executed by the one or more processors, cause the electrical power source to apply voltage between the pair of electrodes such that a plasma is generated,
wherein the generated plasma produces light and has a temperature in a range of 1,000-10,000 K, inclusive.

13. The system of claim 12, further comprising a portable energy device configured to supply power to the electrical power source and/or the control system.

14. The system of claim 13, wherein the portable energy device comprises a primary battery or a secondary battery.

15. The system of claim 12, further comprising a ballast coupled to the pair of electrodes and configured to apply a voltage between the electrodes to initiate the plasma.

16. The system of claim 12, further comprising one or more optical elements configured to redirect, focus, filter, and/or pattern the light.

17. The system of claim 12, further comprising:
a housing in which the pair of electrodes is disposed; and
means for removing debris resulting from generating the plasma and/or means for cooling.

18. The system of claim 17, wherein the means for removing debris and/or the means for cooling comprises a flow of one or more gases through at least part of the housing.

19. The system of claim 17, wherein the housing comprises a window through which at least a portion of the light can pass, and the means for removing debris and/or the means for cooling comprise a flow of one or more gases across and/or proximal to the window.

20. The system of claim 12, further comprising one or more translation devices configured to move one or both electrodes of the pair along the first direction.
